(19) United States
(12) Patent Application Publication
(10) Pub. No.: US 2007/0120683 A1
(43) Pub. Date: May 31, 2007

(54) Implantable electronically-encoded critical health care instruction aka "the Terry"

(76) Inventors: Alexis Flippen, Woodside, CA (US); James H. Flippen, Carmel Valley, CA (US)

Correspondence Address: BELL & ASSOCIATES, 416 FUNSTON ST., SUITE 100, SAN FRANCISCO, CA, 94118, US

(21) Appl. No.: 11/287,050

(22) Filed: Nov. 25, 2005

(51) Int. Cl. G08B 13/14; G08B 1/08

(52) U.S. Cl. 340/572.8; 340/539.11

(57) ABSTRACT

A device adapted for implantation into or onto a human person, the implant comprising a transponder and a memory means for electronically storing and updating information, wherein the information is for critical and/or emergency medical decisions. The device may also include a dental appliqué bonded to a tooth.

### BACKGROUND

Technical advances in modern medicine have lead to an increasing number of situations in which a severely injured or sick person is kept alive, but is unable to communicate his or her wishes regarding critical medical decisions such as resuscitation and intravenous feeding. The ethical dilemmas inherent with such decisions are exemplified by the Terry Schiavo case in which a young woman, having entered a vegetative state, was not able to express her health care wishes, resulting in an acrimonious dispute among her various guardians, relatives and other interested parties. The current invention specifically addresses such issues. It is dedicated to and named in memory of Terry Schiavo.

The record contains a number of references that are relevant to the present invention. Passive electrical transponders are well known in the art and have been used to mark or identify inventory items and livestock with an identifying number or code for inventory purposes. Similar devices have been FDA approved for use in humans. A passive electrical transponder may be quite small and its code may be simply read by an electromagnetic hand-held reader. In operation, the hand held reader is brought into proximity of the transponder and emits a low frequency electro-magnetic field to activate the passive transponder and thereby cause it to transmit its encoded data to the reader. No battery or other power source is required in the passive transponder. U.S. Pat. No. 5,041,826 discloses such a transponder.

U.S. Pat. No. 5,855,609 discloses a passive electrical transponder that may be encoded with a code corresponding to medical information. This transponder may be implanted in a patient's underarm area. The code may be accessed with an electromagnetic hand held reader which is brought into proximity of the transponder. The medical information may itself be directly encoded into the transponder, or into a code used which is then keyed to a corresponding data entry in a data bank or computerized data base accessible over telecommunication lines. This disclosure describes a system wherein medical information relating to patients and medical devices may be centrally collected over an extended time period and analyzed to generate recall notices, provide generalized health information and improve health care for all participants, as well as to support urgent and critical care decisions.

Other relevant publications include U.S. Pat. No. 3,689,885 that describes a device and method in which coded information is returned from a responder to an interrogator in the form of spaced bursts of alternating current of a fixed frequency. In Beigel U.S. Pat. No. 4,333,072, the responder or tag circuit produces a signal by varying the load across the inductor responsive to the encoded signal characteristic of the animal or thing being identified. U.S. Pat. No. 6,012,415 describes a method and apparatus for remotely reading programmed and programmable memories implanted in livestock, particularly for maintaining animal identification, temperature, medial history. U.S. Pat. Nos. 5,300,120, 5,674,288, 5,716,407, 5,725,578, and 5,977,431 describe a number of passive transponders encoded with a number or code of up to 64 binary bits and mounted into a prosthesis or implanted in a human. The transponder's code may be read with a hand held electromagnetic reader. These disclosures describes implants containing information corresponding to patient demographics and implant data to aid in tracking the implant's manufacturer and use for medical and legal reasons.

U.S. Pat. Nos. 5,300,120, 5,674,288, 5,716,407, 5,725,578, and 5,977,431 are all incorporated by reference into this document for all purposes.

Advanced Health Care Directive (AHCD) and living will information is of great importance to an individual, both in terms of specific medical care and with regard to the various moral and ethical decisions a person takes with respect to his or her body, both during and after life. The ethical dilemmas inherent with such decisions is exemplified by the Terry Schiavo case in which a young woman, having entered a vegetative state, was not able to express her health care wishes, resulting in an acrimonious dispute among her various guardians, relatives and other interested parties. The current invention specifically addresses such issues.

At present, AHCD information is generally stored in paper form with an attorney and/or physician. There is one FDA approved implantable chip which can be used to retrieve medical information accessible via scanners and/or the internet, which we shall discuss later. A common way to store medical information is by the use of a bracelet with tags with salient information printed thereon. Another method is to use a device that has integrated into it a magnetic strip or card, for example for attaching to a driver's license.

These solutions have significant shortcomings and disadvantages. They may contain extensive personal medical information not restricted to AHCD, they may present privacy problems, they are often not easily updated, and it may be difficult to maintain accuracy or data. A major problem with many devices is that personal information is stored not in the device itself, but in a computer which often has to be accessed via the internet. This presents major privacy risks and ease of use issues, especially when the internet and/or power is interrupted.

One solution currently approved by the FDA is VeriChip Corporation's VeriMed™ System. This device is a human-implantable RFID microchip used as a patient identification storage and retrieval system. The system uses a handheld reader to read a microchip containing a unique 16-digit ID number. This information is then used to access patient information from a patient database. The physician scans the chip, and then looks up the unique patient ID in a database on a computer, either through the hospital's electronic medical record system or through a Web site. This device does not contain patient-specific medical information, but contains a patient ID number which is then used to retrieve such information. This may take time, and in many situations will not be possible, such as when the internet is unavailable, or mains power is out. This is frequently the case in emergency situations.

There is a need for an implantable information storage device that is both very small any yet can store a meaningful amount of patient information, such as AHCD-related information, in a readable, electronic format. There is a need for such an implantable information storage device that can be read by a simple hand-held reader device, and wherein information may be retrieved directly to the reader device or alternatively to a lap-top or desk-top or palm-top computer or PDA or other device, without any step of accessing a database. There is a need for such an implantable information storage device wherein information may be retrieved directly from the implantable information storage device to the reader device without any step of accessing the internet. There is a need for such a device wherein information may be retrieved directly to the reader device without any step of using a computer other than the reader device. There is a need for such a device that specifically does not store a patient ID number (which may be used to look up patient information) but that stores information relating directly to medical and AHCD-related decisions. There is a need for an implantable information storage device employing one or more passive electrical transponders encoding a code readable by an electromagnetic hand-held reader.

### BRIEF DESCRIPTION OF INVENTION

The invention encompasses a device adapted for implantation into or on to a human, the implant comprising a transponder and a memory means for electronically storing information, wherein the information is medical information. The information generally comprises advanced health care directive information including information concerning resuscitation.

Note that in the current application, the term “Advanced Health Care Directive” (AHCD) is used to encompass any generic information such as information that may be appropriately recorded in a living will or any information that may be of medical relevance and useful or important to communicate even though the subject of the information is not able to communicate, either permanently or temporarily.

The device comprises a means for being energized by a remote reader generally including an induction circuit. Information stored in the device may be read electromagnetically and remotely by a reader that is a held-held, not requiring mains electricity to operate.

The information in the memory means may be read directly in a form understood by an operator without a further step of querying a database or a computer.

The device contains information electronically encoded as a plurality of bits of information, each bit capable of storing a single quantum of information in binary form, and wherein each bit of information corresponds to a single yes/no decision.

The invention also encompasses a device adapted for application onto the tooth of a human, the device comprising a dental appliqué, the appliqué storing information wherein the information is medical information. In some embodiments, the appliqué can be read with the naked eye. In other embodiments, the appliqué comprises a bar code for storing information. In other embodiments it comprises a transponder and a memory means for electronically storing information, wherein the information is medical information.

The invention further encompasses a system for storing and retrieving medical information from a subject, that information being relevant to the subject, the system comprising (a) an implant comprising a transponder and a memory means for electronically storing information, wherein the transponder comprises a means for being energized by a remote hand-held reader, and wherein the information in the memory means may be read directly in a form understood by an operator without a further step of querying a database or a computer, and (b) a hand-held reader. In some embodiments, the hand-held reader is battery operated.

In an alternative embodiment, the invention encompasses a semi-permanent tattoo applied to the body of a subject. The tattoo may be applied in the form of a traditional tattoo using a skin-penetrating needle to inject a dye into the skin, or it may be in the form of any dye applied non-invasively to the surface of the skin. The tattoo includes information generally concerning advanced health care directive information including information concerning resuscitation. The information may be read directly from the tattoo by a health professional. Such a tattoo may be placed on any accessible part of the body, such as on the scalp, arm, inner thigh, foot etc.

In certain embodiments, the information in the tattoo is readable only using black light or under light that causes a fluorescent dye to become visible.

In certain embodiments, the tattoo may be designed so that it can be chemically removed by treatment with a dye-removing chemical or, for example, photo-bleached using laser treatment.

Such embodiments are non-invasive, easy to apply and easy to read in an emergency situation.

### DETAILED DESCRIPTION OF THE INVENTION

The invention encompasses a permanent or semi-permanent device used for storing and rapidly retrieving information such as critical health care instructions such as those contained in an Advanced Health Care Directive (AHCD) and/or living will The device can be implanted in or on an individual, for example subcutaneously or intramuscularly, for example in the back or torso or other minimally vulnerable site. The device may alternatively be permanently or semi-permanently affixed to a prosthesis of any kind such as an insulin pump or pacemaker. The device may alternatively be permanently or semi-permanently affixed to a tooth, for example a molar. In a commercial embodiment, the device would be predictable implanted or affixed at a set location on or within a subject so that a medical worker would always know where to look for such a device.

Information stored in the device may include AHCD information, medical histories, medications, living wills or any other kind of information. Information may be encoded, and retrieved, either directly by use of a reader, or indirectly by use of information stored on a database, accessible via a computer, such as via the internet. In a preferred embodiment, the information is retrievable directly, without the need to refer to a separate database and without the need to access the internet or World Wide Web, which facilities may not always be available and which are vulnerable to tampering and unauthorized access.

Information encoded onto the device of the invention may typically include “do not resuscitate” orders, blood-type information, information about organ and body donation, information about permission to transfuse blood or perform various medical procedures, and drug allergy information and information about analgesia.

The present invention encompasses an implantable information storage device that is both very small and yet can store a meaningful amount of patient information, such as AHCD-related information, in a readable, electronic format. The invention also encompasses an implantable information storage device that can be read by a simple hand-held reader device, a device wherein information may be retrieved directly to the reader device, and in some embodiments, a device wherein the information is retrieved via a computer such as a lap-top, desk-top, palm-top or PDA without any step of accessing a database. An important aspect of the invention is that the information may be retrieved directly from the implantable information storage device to the reader device without any step of accessing the internet. The invention also encompasses a device wherein information may be retrieved directly to the reader device without any step of using a computer other than the reader device. The invention further provides such a device that specifically does not store a patient ID number (which may be used to look up patient information) but that stores information relating directly to medical and AHCD-related decisions.

The invention generally provides an implantable information storage device employing one or more passive electrical transponders encoding a code readable by an electromagnetic hand-held reader. In certain embodiments the transponder is scanned by a reader that emits an electromagnetic pulse or signal. This electromagnetic energy is received by the implanted transponder and induces a current in an inductive circuit which provides electrical power to the transponder to transmit a signal back to the reader, which produces an output signal containing information that may be interpreted or read by a user.

In an alternative embodiment the dimensions of the device may be, for example, no larger than a rice grain, or no larger than a match, for example, the device may be approximately cylindrical and be between 0.1 and 10 mm in diameter, and 1.0 and 30 mm in length, preferably about 0.5 and 5 mm in diameter and between 2 and 10 mm in length, more preferably about 0.5 and 2 mm in diameter and between 2 and 5 mm in length.

In an alternative embodiment the device may be coated with a biocompatible or non-reactive material such as Teflon® or enamel that reduces the probability of colonization by biological substances, fibrosis, encapsulation and scaring.

In one embodiment, the device is implanted in a human subject. The site of implantation may be, for example, subcutaneous, for example, under the forearm, under the arm-pit, in the chest, in the groin, under the scalp, at the base of the neck, on the leg etc. Alternatively the device may be implanted intramuscularly.

In an alternative embodiment the device may not be implanted within the body of the subject, but may be applied to some external part of the body, for example the device may be adhered using an adhesive to the scalp, behind the ear, in the navel, on the chest, under the arm etc of a subject. Suitable adhesives are well known, such as cyanoacrylate and epoxy adhesives.

In an alternative embodiment the device may be placed within some part of the body that is easily and non-surgically accessible such as in the mouth, for example on a tooth, in the ear, such as in the outer ear canal, or in the interior of the nose etc.

In the embodiment in which the device is affixed to a tooth, it may for example be fixed to the second upper maxillary molar so as to provide visual access (tooth No. 2 or No. 15).

The device of the invention may include the following components functionally arranged so as to provide the functionality described herein. The device may include a transponder comprising a receiving and a transmitting circuit. The transponder may be a passive integrated transponder (PIT). The device may further include an induction circuit that produces a potential difference across two points when subjected to electromagnetic radiation from an external source, and a memory means for storing information such as a static RAM chip.

In one exemplary embodiment, the device may be energized by and read by a reader/energizer device. The reader reads information stored on the implanted device using remote sensing. There is no need for physical communication between the implanted device and the reader device. In use, the reader device is generally brought within close proximity to the implanted device which is usually implanted just under the skin of an individual.

The reader/energizer unit may include three main functional units: an exciter, a signal conditioner and demodulation and detection circuits. The exciter may consist of an AC signal source, and a power driver which provides a high current, high voltage excitation signal to an interrogator coil through a capacitor. The interrogator coil and the capacitor are selected to resonate at the excitation signal frequency so that the voltage across the coil is much greater than the voltage output from the driver. The signal conditioner connects to the interrogator coil and serves to amplify the identification signal returned from the PIT while filtering out the excitation signal frequency as well as other noise and undesired signals outside of the frequency range used by the PIT signals. The amplified output of the signal conditioner is fed to the demodulation and detection unit which includes a low pass filter to further reduce excitation signal energy, a frequency shift keyed (FSK) demodulator and a microcomputer. The FSK demodulator is a phase-locked loop circuit configured as a tone decoder which gives a digital output as the signal from the PIT shifts between two frequencies. A microcomputer (CPU) extracts the stored data from this digital output by observing the timing of transitions between the two logic levels. The data obtained by the microcomputer can be transferred to a display or printer, sent over communication lines to a remote point, stored on tape, disk or other storage medium, or sent to another computer. The data may be read directly from the reader/energizer device. There need not be any step of using the data to interrogate a database. The data contained in the PIT is not a patient ID code but actually contains patient information for example AHCD-related information.

In an exemplary embodiment, the passive integrated transponder (PIT) consists of an induction coil which is located such that the magnetic flux generated by the interrogator coil couples energy at the exciter frequency into the PIT. This energy is converted to a DC voltage using a full-wave rectifier bridge and a smoothing capacitor as is commonly used in power supply circuits. This DC voltage supplies the power to a control logic and memory circuit. The control logic element consists of counters and gates which sequentially read out the contents of the memory. The logic element also may insert a sync word into the signal data stream to allow the reader to synchronize to the data. The excitation signal which appears on the PIT coil is supplied to the control logic to provide a clock signal. The logic circuit converts the serial data and sync stream into a frequency shift keyed (FSK) waveform which is connected to the PIT coil through complementary current sinks to transmit the FSK identification signal. The transmitted signal is received by the interrogator coil due to the mutual inductance and is amplified by the signal conditioner and detected. The components above may be separate of may be integrated.

In certain embodiments, the device has encoded within it a code of up to 8, or 16, or 32, or 64 or 128 or 256, or 512, or 1024 (or any multiple thereof) binary bits. Each bit of information corresponds to a single yes/no decision. For example, resuscitate? Yes/No; donate heart? Yes/No; blood transfusion? Yes/No. The reader is programmed to automatically recognize and decode the signal from the device such that it can interpret and communicate each yes/no decision encoded into the implanted device. In this way, the capacity of the device for storing information is maximized while keeping size and cost small.

Importantly, the information in the device can be read directly from the device, and the patient's wishes known immediately, without having to perform the further step of matching an ID number or a code number with a record stored, for example, in a database on a computer or on a server accessible via the internet. Unlike previous solutions and devices, the present device is designed to be usable even without main power or access to the internet. This may be particularly useful in an emergency situation such as in an ambulance, at the road-side, in a battle or during a natural disaster.

In the embodiment wherein the information is stored in an electronic storage device that is attached within the mouth, for example onto a tooth, the device may comprise a transponder in the form of a non-metallic flat disc conforming to tooth topography and fixed in the same way as a crowns using a material that is biocompatible and non conductive both thermally and electrically so as not to introduce discomfort. The device may be bonded to the tooth. The device should be of a size small enough not to cause discomfort or interfere with normal oral activity such as eating or talking. The thickness of the device may be, for example, 0.01 to 0.2 mm thick.

Alternatively, for people who have dentures, the law requires that their name/ID be engraved in the denture which would replace dental records on natural teeth. This same method can be used to store AHCD/health related information. Such engraving may be done by conventional mechanical engraving or etching. In another embodiment wherein the device is attached onto a tooth, the device may comprise a simple non-electronic plaque on which is engraved otherwise displayed instructions. For example the instructions may include or comprise mutually exclusive options readable by the naked eye. Information may be recorded visually on a mylar plaque that is adhered to a tooth with an adhesive. Such an embodiment may, for example, employ a mylar material of ⅛ mm thickness or less. Optionally a sealant may be overlayed on the plaque. Any conventional bonding and sealing method may be employed using any commercially available adhesive and or sealer, provided it is non-toxic and biocompatible. In certain embodiments, a porcelain laminate may be employed.

Durability is an important aspect of the device and the device is designed to remain in place and functional for at least a year, preferably 5, 10, 20, 30, 40 or 60 years or more. This permits discretionary updates and revisions over time.

The device of the invention provides many benefits over prior devices. The device may be implanted and is not easily lost or compromised. The device is easily and directly read using a handheld reader, or visually in the case of a tooth appliqué, without need to access the internet or a database. In a preferred embodiment, the device contains information limited to AHCD information. The invention maximizes the capacity of a very small data storage device to store useful information by having a single yes/no decision correspond to a single bit of electronically stored information. The invention provides improved security because the information is not stored on an external computer or database and is not accessible via the internet but is retrievable by local scanning only. Further, the preferred embodiment permits relative ease of update including non-invasive change-out of the externally affixed dental appliqué or surgical removal/replacement in the case of an implant

### EXAMPLES AND EMBODIMENTS OF THE INVENTION

In one example, the present invention comprises a permanently implantable device used for storing information such as that contained in an Advanced Health Care Directive (AHCD). The device is implanted in an individual subcutaneously behind the ear. The device includes a passive integrated transponder (PIT) and a memory means for storing information such as a static RAM chip. The passive integrated transponder (PIT) consists of an induction coil. Electromagnetic energy transmitted to the coil is converted to a DC voltage that supplies the power to a control logic and memory circuit. The logic circuit converts serial data and sync stream into a frequency shift keyed (FSK) waveform and a transmitted signal is received by the interrogator coil in the hand-held reader. The device has the capacity to store 8 or more binary bits of information. Each bit of information corresponds to a single yes/no decision. For example, resuscitate? Yes/No. The reader is programmed to automatically recognize and decode the signal from the device such that it can interpret and communicate each yes/no decision encoded into the implanted device.

In one example the device works in conjunction with a reader/energizer device that includes an exciter, a signal conditioner, demodulation circuits and detection circuits. The data received from the transponder may be read directly from the reader/energizer device. There is no step of using the data to interrogate a database. The data contained in the PIT is not a patient ID code but actually contains patient information for example AHCD-related information.

In another example, the device comprises a dental appliqué that is affixed to a tooth. The device includes a transponder in the form of a non-metallic flat disc conforming to tooth topography and fixed permanently to the tooth using a biocompatible adhesive.

In another example, the device comprises a non-electronic dental appliqué that is affixed to a tooth. The device displays information in the form of visually readable information as discussed previously.

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A device adapted for implantation into or onto a human, the implant comprising a transponder and a memory means for electronically storing information, wherein the information is medical information.

2. The device of claim 1 wherein the medical information comprises advanced health care directive information.

3. The device of claim 2 wherein the information comprises information concerning resuscitation.

4. The device of claim 1 wherein the transponder comprises a means for being energized by a remote reader.

5. The device of claim 4 wherein the means for being energized comprises an induction circuit.

6. The device of 5 wherein stored the information in the memory means may be read electromagnetically and remotely by a reader.

7. The device of claim 6 wherein the reader is a held-held reader, not requiring mains electricity to operate.

8. The device of claim 6 wherein the information in the memory means may be read directly in a form understood by an operator without a further step of querying a database or a computer.

9. The device of claim 8 wherein the information is electronically encoded as a plurality of bits of information each bit capable of storing a single quantum of information in binary form.

10. The device of claim 4 wherein each bit of information corresponds to a single yes/no decision.

11. A device adapted for adhesion on to onto the tooth of a human, the implant device comprising a dental appliqué, the appliqué storing information, wherein the information is medical information.

12. The device of claim 11 wherein the appliqué comprises a transponder and a memory means for electronically storing information, wherein the information is medical information.

13. The device of claim 11 wherein the appliqué comprises a bar code storing information, wherein the information is medical information.

14. The device of claim 11 wherein the appliqué comprises information readable visually.

15. A method for storing and retrieving medical information from a subject, that information being relevant to the subject, the method comprising (a) implanting into a subject an implant comprising a transponder and a memory means upon which information may be electronically stored, wherein the transponder comprises a means for being energized by a remote hand-held reader, and wherein the information in the memory means may be read directly in a form understood by an operator without a further step of querying a database or a computer, and (b) reading the information in the memory means by use of the remote hand-held reader.

16. The method of claim 15 wherein the remote hand-held reader is battery operated.

17. The method of claim 15 wherein the information is electronically encoded as a plurality of bits of information, each bit capable of storing a single quantum of information in binary form and wherein each bit of information corresponds to a single yes/no decision.
